(19) United States
(12) Patent Application Publication
(10) Pub. No.: US 2005/0151299 A1
(43) Pub. Date: Jul. 14, 2005

(54) Method for bonding thermoplastic materials to other materials using a silane mist

(76) Inventor: L. Keith Rogerson, Isle of Palms, SC (US)

Correspondence Address: DORITY & MANNING, P.A., POST OFFICE BOX 1449, GREENVILLE, SC, 29602-1449, US

(21) Appl. No.: 10/756,190

(22) Filed: Jan. 13, 2004

(51) Int. Cl. B29C 47/00

(52) U.S. Cl. 264/259; 156/245; 156/308.6; 156/329

(57) ABSTRACT

A method for bonding thermoplastic materials to other materials using a silane solution is disclosed. The method includes molding a polymeric article from a thermoplastic resin. During the molding process, a silane solution is atomized or otherwise formed into a mist and contacted with the thermoplastic resin. The thermoplastic resin then becomes doped with the silane. The silane acts as a coupling agent for bonding the thermoplastic resin to other materials, such as foams.

### FIELD OF INVENTION

The present invention is generally directed to a method of bonding various materials such as foam materials to polymeric materials and to articles made therefrom. More particularly, the present invention is directed to a method of bonding foam materials to thermoplastic polymers using silane containing compounds.

### BACKGROUND OF THE INVENTION

Many useful articles are constructed by bonding foams to various structural materials. The foam can be incorporated into the product in order to provide thermal insulation, to provide insulation from noise, to act as a filler, to increase the structural integrity of the article, or for many other various reasons. In the past, when bonding foams to plastic materials, the foams have been primarily used with thermosetting polymers and with composite polymers such as fiberglass. Unfortunately, thermoset plastics are difficult to recycle once used.

In many foam and polymer applications, it would be very desirable to replace the non-recyclable plastics with recyclable materials, such as thermoplastic polymers. In the past, however, many difficulties have been encountered in sufficiently bonding the foam materials to the thermoplastic resins. The prior art teaches using cross-linking agents such as peroxides to form the bond. The cross-linking agents, however, render the polymers non-recyclable, thus removing one of the primary advantages of using them.

For instance, one prior art construction is directed to a process for the production of multi-layer moldings from a substrate member. The process includes bonding an elastomer foam to polypropylene containing a cross linking agent. The cross-linkable polypropylene and elastomer foam are combined and compression molded and then stored under hot conditions in order to increase the degree of cross-linking. As discussed above, however, cross-linking agents can render a thermoplastic resin thermoset in character making the polymer very difficult to recycle.

Generally speaking, the present invention is directed to a method for bonding various materials especially foam materials to thermoplastic polymers without using cross-linking agents. In particular, a silane compound is used for bonding a foam to the polymer. Unexpectedly, through the process of the present invention, no cross-linking agents, such as peroxides, are necessary for establishing a bond between the foam and the polymer. As shown in the accompanying figures, the method of the present invention can be used to construct watercrafts, pallets, thermocoolers, and many other useful articles.

### SUMMARY OF THE INVENTION

The present invention is generally directed to a method of making polymeric and foam articles using a rotational molding technique. According to this method, a mold having an interior surface is first loaded with a predetermined amount of a polymeric material. The amount of the polymeric material added to the mold should be sufficient to cover substantially the entirety of the interior surface. Once loaded, the mold is heated and rotated causing the polymeric material to melt and distribute over the interior surface.

Thereafter, a predetermined amount of mist containing silane solution is sprayed into the mold to dope the polymeric material with silane. The silane solution contained with the silane mist can contain from 0.1% to about 20% silane. The solution can also contain an alcohol having a neutral to basic pH.

Rotation is continued in a manner such that the silane-doped polymeric material distributes over the mold. The molded material is then cooled and bonded to a dissimilar material, such as a foam material.

In particular, the foam material, which can be a polyurethane foam, is bonded to the inner layer comprised of the silane-doped polymeric material. In one embodiment, the polyurethane foam can be formed directly on the shaped polymeric article by reacting a polyol with an isocyanate. It is believed that while the polyurethane is forming it simultaneously bonds with the silane contained within the polymeric material.

In another embodiment, the polymeric shaped article can comprise multiple layers of polymeric materials. The silane-doped thermoplastic resin forms at least one surface on the shaped article for later bonding with the foam material.

Other features and aspects of the present invention are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, in which:

FIG. 1 is a perspective view of a rotational molding apparatus that can be used in the process of the present invention;

FIG. 2 is a perspective view of a polymeric article made in accordance with the present invention;

FIG. 3 is a perspective view with cut away portions of a foam reinforced polymeric pallet made in accordance with the present invention;

FIG. 4 is a perspective view with cut away portions of a watercraft made in accordance with the present invention; and

FIG. 5 is a cross-sectional view of a fogging structure of the present invention used for misting silane solution into a mold;

Repeat use of reference characters in the present specification and drawings is intended to represent same or analogous feature or elements of the invention.

### DETAILED DESCRIPTION OF THE PREFERRED EMBODIMENTS

It is to be understood by one of ordinary skill in the art that the present discussion is a description of exemplary embodiments only, and is not intended to limit the broader aspects of the present invention, which broader aspects are embodied in the exemplary construction.

The present invention is generally directed to a method of bonding various and different materials such as foam materials to recyclable thermoplastic resins. The present invention is also directed to various polymer and foam articles made according to the above method. More particularly, according to the process of the present invention, a thermoplastic resin is doped with a silane compound while the resin is being molded into an article. A different material, such as a polyurethane foam, is then bonded to the article for any desired reason.

As described above, the foam material is bonded to the thermoplastic resin without using a cross-linking agent, such as a peroxide. When cross-linking agents are employed, the thermoplastic resins take on thermoset properties and are no longer easily recyclable. In the present invention, however, the foam materials are bonded to the thermoplastic resins without the resins losing their thermoplastic characteristics.

The resulting polymer and foam articles are lightweight but have substantial structural integrity. Products that can be made according to the process of the present invention include watercrafts, polymeric pallets, polymeric furniture, insulated storage tanks, thermocoolers, children's toys, and many other various items.

Describing the process of the present invention in more detail, first a polymeric material, namely a thermoplastic polymer, is doped with a silane. As used herein, a silane refers to any compound that contains silicon. Preferably, the silane compound used in the present invention is an organosilane having the following general formula:
R—SiX₃
wherein R is an organofunctional group and X is a hydrolyzable group that may convert to silanol on hydrolysis. In some embodiments, R can include a propylene group bonded to various other groups such as chlorine, a methacrylate group, or an amino group.

The X in the above formula, on the other hand, is typically an alkoxy group such as a methoxy group. Preferably, the SiX₃ group is a trimethoxysilane.

Commercially available silane coupling agents that can be used in the process of the present invention can be obtained from Dow Corning Corporation, located in Midland, Mich. One preferred silane coupling agent available from Dow Corning Corporation is N-(2-aminoethyl)-3-aminopropyltrimethoxysilane which has the following chemical formula:
NH₂CH₂CH₂NH(CH₂)₃Si(OCH₃)₃

As stated above, the chosen silane compound is used as a dopant in being combined with a thermoplastic polymer. As used herein, a silane-doped thermoplastic resin refers to a thermoplastic polymer that has been treated with a silane compound. Generally, any thermoplastic polymer or resin may be used in the process of the present invention. In particular, polyolefins such as homopolymers and copolymers of polypropylene, polyethylene, polybutylene or mixtures thereof, or vinyl polymers such as polyvinyl chloride or a polystyrene may be used. The particular polymer chosen for use in the present invention will depend upon the particular article being made and the physical characteristics that are desired.

Silane compounds are typically commercially available in either a dry form or as a concentrate. It has been found that when used in the present invention, it is preferable to place the silane in an aqueous solution prior to application to the thermoplastic polymers.

The silane solution used in the present invention contains from about 0.1% to about 30% by weight silane and preferably contains about 5% by weight silane. The remainder of the solution can comprise water or can include water and a stabilizer. Preferably, the stabilizer is an alcohol, such as isopropyl alcohol or etherglycol. When present, the stabilizer can be added in amount from about 5% to about 10% by volume.

According to the present invention, during a process for molding a polymeric article, the silane solution is sprayed on to at least one surface of the article during the molding process. For example, in one embodiment, the silane solution can be sprayed on to the molded article after the article has formed but prior to cooling the article. The silane solution serves as a dopant on a surface of the article for later bonding the article to a different material.

Once molded to a particular shape, the polymeric article is then preferably cooled (for instance, below about 125° F.). Silane remains on the surface of the shaped article and provides reactive sights for bonding with various materials such as foam materials. It has been found, that after melting and hardening the resin, the silane groups become much more amenable to reaction with a foam material for bonding the foam material to the polymer. The reasons for this phenomenon, thus far, remain unknown.

In one embodiment, a layered polymeric product can be made using a rotational molding technique. Various embodiments of rotational molding apparatus that may be used in the present invention are disclosed in U.S. Pat. No. 5,358,682 which is incorporated herein in its entirety by reference thereto, and in which the present inventor is also the listed inventor. In addition to rotational molding, however, it is believed that the process of the present invention can also be used in conjunction with blow molding, injection molding, and any other suitable molding process.

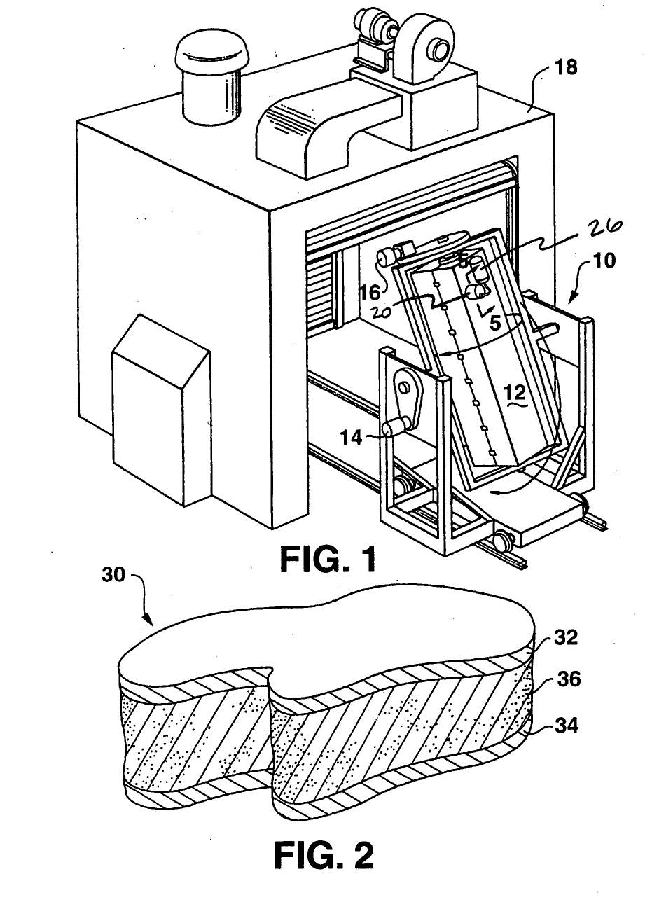

Referring to FIG. 1, one embodiment of a rotational molding apparatus generally 10 is illustrated. Rotational molding apparatus 10 includes a mold that, as shown by the arrows, can be rotated about two different axes. In particular, rotational molding apparatus 10 includes a first motor 14 for rotating mold 12 about the X axis and a second motor 16 for rotating mold 12 about the Y axis. Rotational molding apparatus 10 further includes a chemical injector 20 which will be described in more detail hereinafter.

When rotational molding apparatus 10 is used according to the process of the present invention, a charge of polymeric material is first loaded into mold 12. Rotational molding apparatus 10 is then wheeled into an oven 18 and heated while mold 12 can be rotated about the Y axis and/or the X axis. Mold 12 is heated to a temperature sufficient to cause the polymeric material contained therein to melt and distribute over the inside walls of the mold.

Whether formed through rotational molding, blow molding, injection molding or any other, means, once a polymeric article is formed containing a silane-doped thermoplastic polymer, according to the present invention a dissimilar material such as a foam material can then be bonded to the article as desired. Specifically, the foam material is bonded to a surface of the article comprised of the silane-doped polymer. The silane contained within the polymer acts as a coupling agent between the polymer and the foam.

Although it is believed that other foam materials may be bonded to the silane-doped thermoplastic resin, preferably a polyurethane foam is used. Polyurethanes are versatile polymers that can be used in forming foam products with a wide range of hardnesses and densities.

Polyurethane foams are typically made by reacting two major chemical components together that are metered and mixed in a preselected ratio. The two major chemical components mixed to produce the foam are a polyol and an isocyanate. Other ingredients can be added as needed for producing a specific type of foam. These other additives may include water, auxiliary blowing agents, catalysts, fillers, coloring agents, and surfactants.

The polyol that is used to make polyurethane foams is typically a diol. For instance, in one embodiment, the polyol can be a copolymer of ethylene glycol and adipic acid. The isocyanate used to make the foam, on the other hand, is typically a diisocyanate. One example of a commercially available polyurethane foam that may be used in the process of the present invention can be obtained from Flexible Products Company located in Marietta, Ga. Specifically, the foam product is made by combining a polyol component with an isocyanate component. It is believed that the isocyanate used is a diphenyl methane diisocyanate.

Polyurethane foams are generally formed using a spraying method or a pouring method. Spraying, which is generally used to produce rigid foams, refers to a process by which the chemical reactants are mixed and sprayed onto a surface where the foaming reaction occurs. In the pouring method, the reactants are dispensed and mixed in an open cavity or in a closed mold where the reaction take place and the foam is formed.

When using a polyurethane foam in the process of the present invention, the foam may be formed upon the polymeric article. While the foam is forming, the foam then reacts and bonds to the silane contained within the thermoplastic polymer.

For example, in one embodiment, a liquid resin containing a polyol and a liquid isocyanate initiator can be kept in separate tanks under a nitrogen blanket. The two components can then be shot out through a hose onto or into the formed polymeric article. Although, the amounts will depend upon the particular polyurethane foam used, the polyol resin and the isocyanate can be mixed and dispensed onto the polymeric article in about a one to one ratio. Once the components are applied to the polymeric article, a polyurethane foam will form that simultaneously bonds to the silane-doped thermoplastic polymer.

Of particular advantage, the foam can be formed and bonded to the polymeric article at lower temperatures, below 100° F. Thus far, it has been found that the foam will adequately form and bond to the polymeric article at temperatures between about 65° F. to about 85° F. and preferably at about 80° F.

Besides foam materials, the silane doping process of the present invention can also be used to bond other various materials to thermoplastic resins. Generally speaking, any material that reacts and bonds with silane can be coupled to the silane-doped thermoplastic resin. More particularly, it is believed that many thermosetting polymers can be bonded to a silane doped thermoplastic resin made in accordance with the present invention. For instance, it is believed that the silane doped thermoplastic resin will bond to epoxies, phenolics, melamines, nylons, polyvinyl chloride, acrylics, urethanes, non-foam polyurethanes, nitrile rubbers, polyesters, polysulfides and others.

When bonding thermosetting polymers and other similar types of materials as listed above to a silane doped thermoplastic resin, preferably the dissimilar material is formed on the surface of the silane doped thermoplastic resin and bonded therewith similar to the process described above using polyurethane foams. Depending upon the material being bonded to the silane doped resin, heat may need to be supplied in order to get the materials to bond together or in order to form the non-doped material.

Many advantages can be realized when bonding thermoplastic resins, especially polyolefins, to different materials, such as thermosetting polymers, rubber-type materials, and other various non-foam materials. For instance, it is now possible through the process of the present invention to coat an article made from a thermosetting polymer with a polyolefin or to coat an article made from a polyolefin with a thermosetting polymer.

Many varieties and types of useful articles can be formed according to the above described process. For instance, articles for use in the building and construction field can be formed, furniture and furniture parts can be constructed, articles for use in motor vehicles can be made, and insulated panels for refrigeration units can be made.

For exemplary purposes only, FIG. 2 illustrates a layered polymeric and foam article generally 30 that can be made in accordance with the present invention. Article 30 includes a layer of foam material 36 sandwiched between a first layer of polymeric material 32 and a second layer of polymeric material 34. Preferably, foam material 36 is a polyurethane foam while first layer 32 and second layer 34 are made from a thermoplastic polymer. In particular, layers 32 and 34 can be made exclusively with a silane-doped thermoplastic resin or can be made from layers of various polymers as long as the inner surface in contact with foam material 36 is doped with a silane compound.

A polymer and foam article as exemplified by FIG. 2 can be used in a variety of applications. The foam and polymer structure can be used as an insulator or can be used for its structural strength. In particular, such articles have a high strength to weight ratio and display a greater rigidity than solid parts of the same material and equal weight.

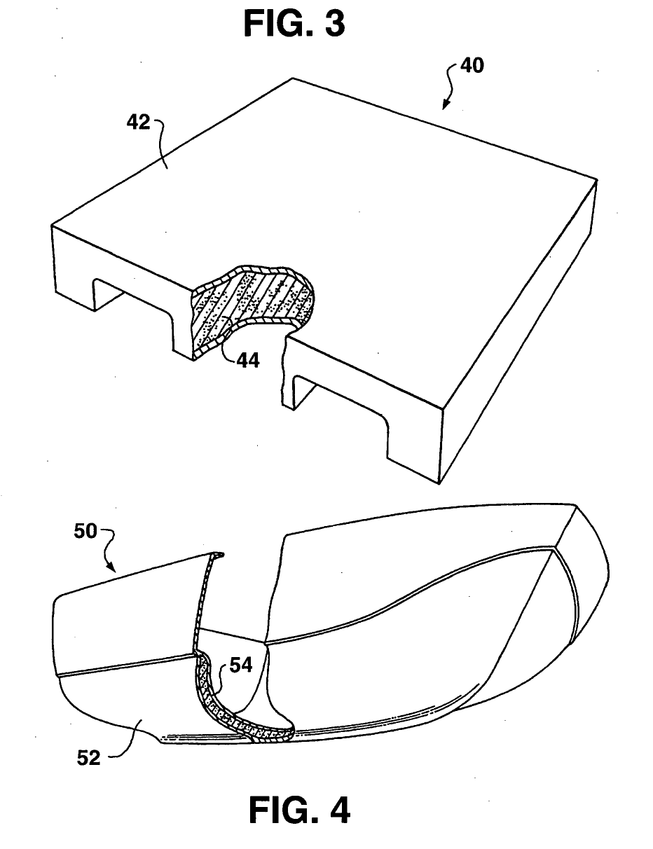

Referring to FIG. 3, a specific article that can be made according to the process of the present invention is a polymer and foam pallet generally 40. Pallet 40 includes a shell of polymeric material 42 bonded to an interior layer of foam 44. Again, foam 44 is securely bonded to the interior surface of polymeric shell 42 through the use of a silane coupling agent.

In a preferred embodiment, outer shell 42 of pallet 40 is made from a silane-doped thermoplastic resin. The thermoplastic resin provides structural support and is completely recyclable. In fact, as stated above, foam material 44 is bonded to shell 42 without the use of a cross-linking agent. Thus, shell 42 retains its thermoplastic characteristics. Further, by having shell 42 securely bonded to foam layer 44, a coherent, lightweight and structurally sound article is produced.

Referring to FIG. 4, another article of manufacture, a watercraft or boat generally 50, that can be made in accordance with the present invention is illustrated. Boat 50 includes a hull 52 made solely from thermoplastic polymers. As shown, at least a portion of the inside surface of hull 52 is made form a silane-doped thermoplastic polymer which is bonded to a foam material 54 such as a polyurethane foam. When incorporated into boat 50, foam material 54 not only provides structural integrity to the hull but also provides noise insulation when the boat is moving through the water.

Currently, boats and various watercrafts such as illustrated in FIG. 4 are made using fiberglass. Fiberglass, however, is not currently recyclable and is difficult to dispose of. As such, a boat, or watercraft, as constructed in FIG. 4 provides various advantages and benefits not before realized.

The process of doping a thermoplastic resin with a silane can be accomplished by various processes. In one embodiment, the thermoplastic resin is immersed in a silane solution, and the silane-doped resin is then loaded into a molding apparatus, such as a rotational molding apparatus for forming an article. However, in some applications, it may be desirable to apply the silane to the thermoplastic resin while simultaneously molding the resin.

As such, another embodiment of the present invention includes a rotational molding apparatus that can perform the multiple functions of heating a thermoplastic resin, molding the thermoplastic resin into an article, and doping the thermoplastic resin with silane. In accordance with the present invention, the silane may be sprayed into the mold during the molding process for doping the polymeric material.

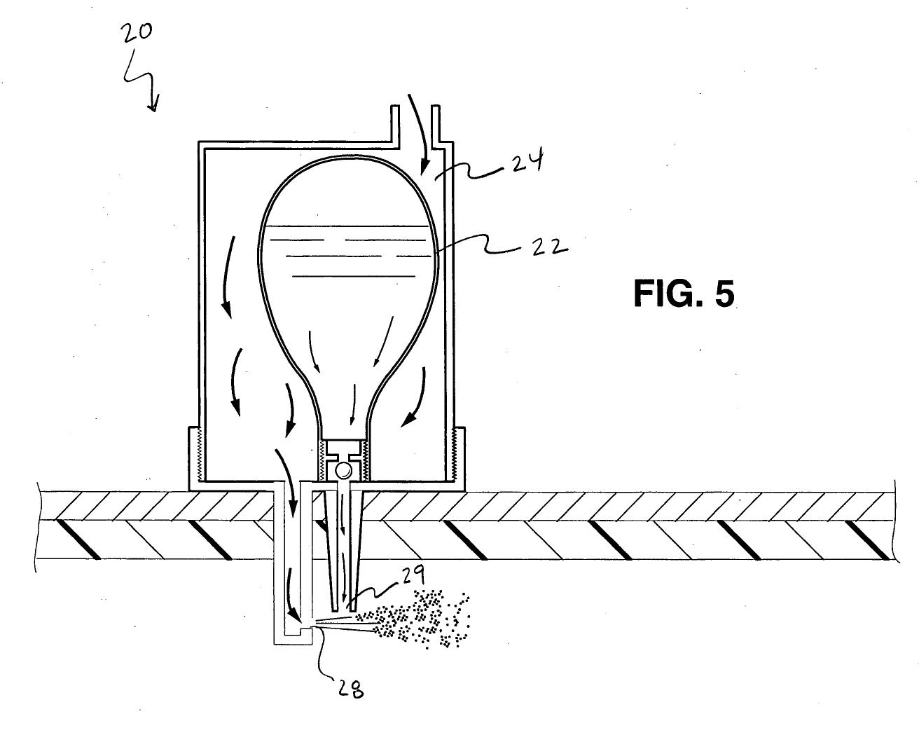

For instance, referring to FIGS. 1 and 5, the rotational molding apparatus 10 further includes a chemical spray injector 20 which is designed to spray a silane solution into the mold. In general, any suitable spray injector that may be placed in communication with a molding apparatus may be used in the present invention for applying a silane solution to a molded article. One example of a chemical injector 20 is shown in FIG. 5.

In the embodiment illustrated in FIG. 5, the chemical injector 20 includes a liquid reservoir 22 that is designed to contain a silane solution. The liquid reservoir 22 is contained within a gas chamber 24 which is in communication with a gas supply 26 as shown in FIG. 1. In this configuration, a pressurized and inert gas is fed to the gas chamber 24 which causes silane to be released from the liquid reservoir 22. The inert gas can be any gas that does not interfere with the molding process. The gas can be, for instance, air, molecular nitrogen, argon, mixtures thereof, and the like. The inert gas is also forced through a nozzle 28 which is placed adjacent to an opening 29 through which the silane is emitted. In this manner, the gas contacts the silane solution to form a silane mist or fog. For instance, in one embodiment, the gas being emitted from the nozzle 28 atomizes the silane solution.

Once formed into small droplets or a mist, the silane solution evenly coats the interior surface of the mold as the mold is rotating along one or more axis.

The amount of silane solution required varies depending on the particular application and the size of the mold. In one embodiment, for example, about one ounce of silane solution is used. When rotational molding apparatus 10 is used to perform the multiple functions of molding and silane doping according to the process of the present invention, a charge of polymeric material is first loaded into mold 12. Rotational molding apparatus 10 is then wheeled into an oven 18 and heated while mold 12 can be rotated about the Y axis and/or the X axis. Mold 12 is heated to a temperature sufficient to cause the polymeric material contained therein to melt and distribute over the inside walls of the mold.

Once the polymeric material has distributed within mold 12, a mist or fog of silane can be released into the mold by injector 20 as described above. The mist dopes the thermoplastic resin with silane.

In one embodiment, approximately one ounce of silane mist is applied to mold 12 near the end of the cycle (at about 12-16 minutes). If the silane is released by the injector 20 at an earlier point in the heating cycle (e.g. 8 minutes), a thicker layer of silane doped resin can form. Likewise, if the silane mist is released by injector 20 after the end of the heating cycle and during the cooling cycle, a thinner layer of silane-doped resin can form. Although it is preferred that the silane mist be released near the end of the heating cycle, the mist can also be released at numerous other points during the heating or cooling cycles, depending on the particular application.

In some embodiments, the silane may be injected into the molding apparatus at higher temperatures to prevent against shock cooling of the polymeric structure. Shock cooling can occur, for instance, at temperatures less than about 280° F., especially during crystallization of the polymer. Shock cooling of the polymer, however, is not a problem at higher temperatures.

In one embodiment, in order to prevent against shock cooling, the silane solution can be released into the mold at lower temperatures if the silane and/or injection gas are preheated prior to being emitted.

Once the thermoplastic resin is doped with silane by injector 20, the interior layer provides a surface for bonding with foam materials. For example, a polyurethane foam can be formed upon and bonded with the silane-doped resin as described above.

In the embodiment illustrated in FIG. 1, the molding apparatus 10 includes a single chemical injector 20. In other embodiments, however, it should be understood that the molding apparatus can include greater numbers of chemical injectors depending upon the size of the mold and the amount of silane that needs to be injected into the mold.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A method of doping polymeric materials with a silane, said method comprising the steps of:
placing a thermoplastic resin into a mold;
heating said thermoplastic resin to a temperature sufficient to begin melting said resin;
contacting said heated thermoplastic resin with a mist comprising a silane solution, such that said heated thermoplastic resin becomes doped with said silane solution while within said mold; and
molding said thermoplastic resin into a polymeric article, such that said article has at least one surface comprised of silane-doped thermoplastic resin, said at least one surface being adapted for bonding with different materials.

2. A method as defined in claim 1, wherein said silane solution comprises from about 0.1% to about 30% by weight silane.

3. A method as defined in claim 1, wherein said silane solution further comprises an alcohol, said alcohol being present in said solution in an amount from about 5% to about 10% by weight.

4. A method as defined in claim 1, wherein said silane solution contains a silane compound having the following formula:
R—SiX₃
wherein R is an organofunctional group and X is an alkoxy group.

5. A method as defined in claim 4, wherein said silane compound is a trimethoxysilane.

6. A method as defined in claim 1, wherein said thermoplastic resin is a homopolymer or copolymer of a polyolefin.

7. A method as defined in claim 1, further comprising the step of molding said silane-doped thermoplastic resin into a polymeric article comprised of multiple layers of polymeric materials, said silane-doped thermoplastic resin forming at least one exterior surface on said article.

8. A method as defined in claim 1, wherein a polymeric material is loaded into said mold prior to said thermoplastic resin, said thermoplastic resin thereby forming an inner layer over at least a portion of said polymeric material, said inner layer of thermoplastic resin being adapted for bonding with different materials when contacted with said silane mist.

9. A method as defined in claim 1, wherein a polymeric material is loaded into said mold after said thermoplastic resin is added to said mold and contacted with said silane mist, said silane-doped thermoplastic resin thereby forming an outer layer over at least a portion of said polymeric material that is adapted for bonding with different materials.

10. A method as defined in claim 1, wherein the thermoplastic resin is rotationally molded into said polymeric article.

11. A method as defined in claim 1, wherein said thermoplastic resin is a polyethylene.

12. A method as defined in claim 1, wherein said mist is formed by combining a gas with said silane solution.

13. A method of making polymeric and foam articles, said method comprising the steps of:
placing thermoplastic resin particles into a mold;
heating said thermoplastic resin particles to a temperature such that said resin particles begin to melt;
contacting said heated thermoplastic resin with a mist comprising a silane solution, such that said heated thermoplastic resin particles become doped with said silane solution;
rotationally molding said silane-doped thermoplastic resin particles into a shaped article;
cooling said shaped article for hardening same; and
bonding a foam material to said shaped article for producing a polymeric and foam article.

14. A method as defined in claim 13, wherein said silane solution comprises about 0.1% to about 30% by weight silane, said silane having the following formula:
R—SiX₃
wherein said R is an organofunctional group and X is an alkoxy group.

15. A method as defined in claim 13, wherein said silane further comprises an alcohol.

16. A method as defined in claim 13, wherein said silane solution is preheated prior to contacting the thermoplastic resin.

17. A method as defined in claim 13, wherein said foam material comprises a polyurethane foam.

18. A method as defined in claim 17, wherein said polyurethane foam is formed directly on a surface of said shaped article by combining and reacting a polyol with an isocyanate.

19. A method as defined in claim 18, wherein said polyurethane foam is formed on said surface at a temperature less than 100° F.

20. A method as defined in claim 13, wherein said mist is formed by combining gas with said silane solution.

21. A method as defined in claim 13, wherein said heated thermoplastic resin is contacted with said mist after cooling of said shaped article has begun.

22. A method for making polymeric and foam articles, said method comprising the steps of:
loading a predetermined amount of a first thermoplastic resin into a mold having an interior surface, said amount of thermoplastic material being sufficient to cover substantially the entirety of the surface;
rotating said mold while heating said mold, wherein said polymeric material is heated and distributed over said interior surface;
loading said mold further with a second thermoplastic resin while said mold is at a temperature sufficient to melt said resin, wherein said rotation and heating of said mold is continued in a manner such that said second thermoplastic resin is distributed over at least a portion of said first thermoplastic resin;
loading said mold further with a mist comprising a silane solution such that said mist sufficiently dopes said second thermoplastic resin with silane solution;
cooling said molded polymeric article; and
bonding a foam material to said inner layer comprised of said silane-doped thermoplastic resin to form a polymeric and foam article.

23. A method as defined in claim 22, wherein the silane solution is preheated prior to being loaded into the mold.

24. A method as defined in claim 22, wherein said first and second thermoplastic resins are comprised of homopolymers and copolymers of polyolefins.

25. A method as defined in claim 24, wherein said first and second thermoplastic resins are comprised of polyolefins.

26. A method as defined in claim 22, wherein said foam material is a polyurethane foam.

27. A method as defined in claim 26, wherein said polyurethane foam is simultaneously formed and bonded to said inner layer comprised of the silane-doped thermoplastic resin, said polyurethane foam being formed by combining a polyol with an isocyanate.

28. A method as defined in claim 22, wherein said silane solution comprises silane having the following formula:
R—SiX₃
wherein R is an organofunctional group and X is an alkoxy group.

29. A method as defined in claim 22, wherein said mist is formed by combining a gas with said silane solution.

30. A method as defined in claim 22, wherein said mist is loaded into said mold after cooling of said molded polymeric article has begun.
